(19) United States
(12) Patent Application Publication
(10) Pub. No.: US 2014/0272238 A1
(43) Pub. Date: Sep. 18, 2014

(54) Water-Shedding Flashings

(71) Applicant: MITEK HOLDINGS, INC., Wilmington, DE (US)

(72) Inventor: Ronald P. Hohmann, JR., Hauppauge, NY (US)

(73) Assignee: MITEK HOLDINGS, INC., Wilmington, DE (US)

(21) Appl. No.: 14/210,670

(22) Filed: Mar. 14, 2014

Related U.S. Application Data
(60) Provisional application No. 61/787,433, filed on Mar. 15, 2013.

(51) Int. Cl. E04B 1/70; B29C 47/00; B29D 99/00; E04B 1/68

(52) U.S. Cl. CPC E04B 1/7046; E04B 1/6803; B29C 47/0004; B29C 47/0021; B29D 99/005
USPC 428/41.8; 264/211; 428/343; 524/567; 524/570; 524/586; 524/587; 524/605; 524/584; 524/575; 524/574; 524/430; 524/413

(57) ABSTRACT

A water-shedding flashing is sized and shaped to drain water away from a building. The flashing includes an elongate flexible membrane including a matrix and hydrophobic material within the matrix. The hydrophobic material within the matrix is present at surfaces of the membrane in quantities to reduce surface adhesion of water on the elongate flexible membrane.

### BACKGROUND OF THE INVENTION

1. Field of the Invention

This invention relates to an improved flashing for cavity wall structures. More specifically the invention relates to water-shedding flashings having a super-hydrophobic surface that facilitates drainage within the wall cavity and provides protection against deterioration of the structure and against mold and mildew growth. The flashings are designed to communicate with the exterior of the cavity wall and operate as a conduit between the cavity and the channels throughout the exterior surface of the outer wythe to remove water and water vapor from the cavity.

2. Description of the Prior Art

In the past, investigations relating to cavity wall flashing systems for brick veneer masonry construction have been conducted. While strides have been made in flashing-related technologies, including metal foils, embossed channels, polymeric and elastomeric materials and hot melt adhesives, there still remain several areas where continued development is ongoing.

The inventors' patents and their assignee's product line are related to accessories for cavity wall structures and include masonry flashing, insulation, and anchoring and seismic devices, and are sold under the trademarks of Seismiclip®, Byna-Tie®, and DW-10-X®, X-Seal®, Foam Tech®, and Flex-Flash™. These products, which are manufactured by Hohmann & Barnard, Inc., Hauppauge, N.Y. 11788, a unit of MiTek Industries, Inc., a Berkshire Hathaway subsidiary, and have become widely accepted in the construction industry, providing the inventors with particular insight into the technological needs of this marketplace.

Because of widespread usage and familiarity with bituminous and asphaltic products in roofing applications, when masonry flashing systems were first designed, the building construction industry adopted the familiar copper and asphalt products. At that time the technology of pressure-sensitive hot melt adhesives needed for peel-and-stick applications was insufficiently developed. Some critics indicated that the tackiness of the non-asphaltic products was insufficient for the rough masonry block surfaces.

Because of the presence of plasticizers, others were apprehensive about the available hot melt adhesives meeting the requisite fire retardancy standards. Also, to provide fire retardancy, some pressure-sensitive products were marketed for building construction use with inorganic fillers, such as alumina trihydrate, antimony oxide or calcium carbonate. However, these filled pressure-sensitive products had disadvantages, such as application problems, phase separation, toxicity, and reduced adhesion upon activation.

The inventors hereof have in inventions related hereto made improvements in the masonry flashing art. Hohmann et al., U.S. Pat. No. 6,584,746 issued Jul. 1, 2003; U.S. Pat. No. 6,928,780 issued Aug. 16, 2005; and U.S. Pat. No. 6,945,000 issued Sep. 10, 2005; provide masonry flashing systems which are suitable either for surface-mounting with a termination bar or for through-wall mounting. The devices use state-of-the-art adhesives and various flashing membranes and composites.

Masonry walls with brick veneer are designed with an inner and an outer wythe and a cavity therebetween. The backup wall or inner wythe and insulation thereon isolates the interior of the building from the environment, and the brick veneer outer wythe provides an aesthetic finish to the building and a system of weep holes, channels or channeled flashing for removing fluids from the cavity. The inner wythe is constructed to exclude water and water vapor from the interior. Where excessive levels of water or water vapor are present in the cavity, the deterioration of building materials is hastened. Various masonry flashing systems in the past have been adopted to function cooperatively with the system of weep holes and remove water and water vapor from within the cavity. However, the nature of the flashing materials caused water and water vapor to adhere to the surface, limiting the removal of water and water vapor from the cavity.

The existence of moisture in the cavity hastens the growth of mold, mildew and other unwanted infestations within the cavity and causes the weakening of the physical integrity of the building materials. Improvements in the thermal insulation of cavity wall structures reduces heat exchange between the interior of the building and the exterior surface. Such insulation improvements, while conserving energy and lowering HVAC costs, provides a more friendly atmosphere for mold, mildew and other unwanted microorganism infestation within the cavity. Accordingly, it is essential that water and water vapor be removed from the cavity and directed to outside the exterior of the building.

The present invention focuses on the issue of water removal within the wall cavity through the use of specialized coatings and modified surfaces, which produces a novel super-hydrophobic surface. The level of water repellency in flashings is greatly affected not only by the water repellency characteristics of the materials, but also by the surface condition. This ultimate goal of water repellency is achieved by providing a level of super-hydrophobicity where the water contact angle is in the range of at least 120 degrees and preferably over 150 degrees. This water contact angle is often referred to as the lotus leaf effect because the lotus leaf surface is known to be naturally super-hydrophobic due to the texture of its waxy surface. This small contact level inhibits adhesion of the water and water vapor with the flashings, causing the water and water vapor to quickly flow down the flashings to the weep holes and ultimately to the exterior of the building. The expulsion of water and water vapor from the cavity removes the medium for mold and mildew growth.

In preparing for this application the below-mentioned patents, some of which are discussed above, came to the attention of the inventors. The other patents are believed to be relevant to the further discussion of the prior art, which follows:

| Pat. | Inventor | Issue Date |
|---|---|---|
| 6,945,000 | Hohmann et al. | Sep. 20, 2005 |
| 6,928,780 | Hohmann et al. | Aug. 16, 2005 |
| 6,584,746 | Hohmann et al. | Jul. 1, 2003 |
| 5,870,864 | Snyder | Feb. 16, 1999 |
| 5,860,259 | Laska | Jan. 19, 1999 |
| 4,910,931 | Pardue | Mar. 27, 1990 |

### PUBLISHED PATENT APPLICATIONS

| Pat. Application | Inventor | Pub. Date |
|---|---|---|
| US 2007/0197717 | Ueda et al. | Aug. 23, 2007 |
| US 2002/0053300 | Beckenhauer | May 9, 2002 |
| US 2005/0028455 | Koch et al. | Feb. 10, 2005 |

U.S. Pat. No. 5,870,864—Snyder—Issued Feb. 16, 1999 Snyder describes a drainage system employing water collection pans which for insertion into the interior cavities of masonry block units over the length of a selected block wall course for collecting the water drained through the interior cavities of the upper courses and directing water to the exterior of the wall.

U.S. Pat. No. 5,860,259—Laska—issued Jan. 19, 1999 Laska describes an insulated drainage panel for use in cavity wall or veneer wall construction which panel includes a planar insulating board with a porous structure thereof.

U.S. Pat. No. 4,910,931—Pardue—issued Mar. 27, 1990 In the Pardue patent, a water collection and drainage system is described for a masonry block wall having bond beam block courses and intervening standard block courses. A system of upper water collection pans is supported along each upper bond beam course. Downspouts leading from drain openings in the upper collection pans drain collected from the pans through the vertical block cavities in lower block courses to the next lower series of collection pans. Weeping spouts lead laterally from the base collection pans to the exterior of the wall to continuously drain collected water from the interior wall cavities.

US Patent Application Publication No. 2007/0197717—Ueda et al.—Pub. Date Aug. 23, 2007 Ueda details a treating agent containing a fluoropolymer for use with masonry. The treating agent imparts water repellency on the masonry and is applied one or more times by brushing, spraying, rolling, dipping, or using rags. After application, the treatment agent is dried to remove the liquid medium.

US Patent Application Publication No. 2002/0053300—Beckenhauer—Pub. Date May 9, 2002 The Beckenhauer application details methods and compositions used to increase water resistance of concrete, masonry or wood building materials. To achieve water resistance, a selected amount of an aqueous treating solution is applied to the material surface.

US Patent Application No. 2005/0028455—Koch, et al.—Pub. Date Feb. 10, 2005 The Koch application describes a combination flashing and drainage system that works with a hydrophillic system. The system described uses a layer of polypropylene or equivalent as a wicking material to transport water. As wicks are hydrophilic, water is moved from wetter to drier areas of the wick and are reversible. The Koch et al. system relies on evaporation at the outer exterior edge thereof to reduce the total water content.

The super-hydrophobic masonry flashings of this invention are treated and specially coated to facilitate the removal of water and water vapor from the cavity. The pre-treated flashings are useable within any cavity wall structure, easy to install, and effective in removing water and waper vapor from the cavity. Further, the use of the super-hydrophobic masonry flashings remove the need to provide a chemical coating directly to the masonry to protect the masonry against water damage and mold growth. The flashings are optionally surface- or through-wall mounted with clear, pressure-activated adhesive thereon. With the addition of a release sheet atop the optional adhesives, these flashings become labor-saving peel-and-stick devices readily mounted in the cavity between the inner wythe and the outer wythe as described infra. The structure of this invention has been found to obviate the difficulties discussed above and among advantages as set forth herein, provides for super-hydrophobic flashings with attributes not found, nor taught toward, in the prior art.

### SUMMARY

In one aspect, a water-shedding flashing is sized and shaped to drain water away from a building. The flashing comprises an elongate flexible membrane including a matrix and hydrophobic material within the matrix. The hydrophobic material within the matrix is present at surfaces of the membrane in quantities to reduce surface adhesion of water on the elongate flexible membrane.

In another aspect, a method of making a water-shedding flashing comprises providing a matrix material. A hydrophobic material is introduced to the matrix material. The matrix material and the hydrophobic material are mixed to form a matrix. An elongate flexible membrane sized and shaped to drain water away from a building is extruded from the matrix to form a water-shedding flashing having the hydrophobic material present at the surfaces of the elongate flexible membrane.

### OBJECTS AND FEATURES OF THE INVENTION

In general terms, the water-shedding flashing of this invention provides a flashing having an elongated membrane with a modified and unmodified surface. The unmodified surface is mounted on the exterior of the inner wythe. A pressure-activated adhesive is added to the unmodified surface together with a release sheet thereover, forming a peel-and-stick assemblage. This facilitates a labor-saving application of the multi-functional device. The modified surface is opposite the unmodified surface, facing the cavity, and conditioned for adhering with a super-hydrophobic layer. The super-hydrophobic layer is disposed on the modified surface and configured to reduce the surface adhesion of water and water vapor on the flashing, causing the water to be shed from the flashing and facilitating the removal of water and water vapor from the cavity through the channels to the exterior of the outer wythe.

The description which follows suggests the best modes and methods of producing the invention. The invention utilizes a broad range of suitable methods for conditioning the modified surface, which include, but are not limited to, etching, chemical-vapor-deposition and abrasion. Similarly, the invention utilizes a broad range of super-hydrophobic layers, which include, but are not limited to, textured metal oxides and compounds with low surface energy. The novel benefits of the water-shedding flashing include a water contact angle of at least 120 degrees, causing water and water vapor to bead and roll down the surface of the flashing and out to the exterior of the cavity wall structure. The water-shedding flashing may optionally be produced as a self-regenerating and self-healing flashing.

The water-shedding flashing in the peel-and-stick form includes inter alia a hot melt adhesive. The various embodiments utilize various adaptations of the basic formulation and include clear adhesives and adhesives with additives. All the adhesives meet flammability standards and are resistive to wide swings in ambient temperatures. This precludes drooling of the adhesives and the concomitant marring of exterior wall surfaces. In one embodiment using creped HDPE, the adhesive layer is doped with fiber glass or polyethylene fiber fragments. In applications in which the water-shedding flashing is adhered to a porous masonry block backup wall, the tackifier resin content is optionally increased.

It is an object of the present invention to provide a super-hydrophobic masonry flashing for cavity wall construction.

It is a further object of the present invention to apply a specialized coating, surface condition, or a combination thereof to the flashing to impart a super-hydrophobic surface condition.

It is a further object of the present invention to provide for surface- or through-wall-mounting to the inner wythe a peel-and-stick super-hydrophobic flashing membrane having a pressure-activated, clear adhesive thereon which, upon removal of a release sheet and application of pressure thereto, strongly adheres to the rough and porous surfaces of the backup wall and the brick.

It is yet another object of the present invention to provide a labor-saving masonry flashing which utilizes peel-and-stick components that are easy and economical to install in cavity wall constructs having a masonry block or drywall inner wythe and a brick or veneer outer wythe.

It is still yet another object of the present invention to provide a masonry flashing which has super-hydrophobic properties that reduces water and water vapor adhesion, facilitating the removal of water and water vapor from the cavity to the exterior of the structure through the weep holes.

It is a feature of the present invention that the super-hydrophobic flashing hereof provides for expeditious drainage of water and water vapor from the cavity deterring mold and mildew growth.

It is another feature of the present invention that the flashing membrane hereof is highly durable and the adhesive layer of the flashing enhances tear and puncture resistance of the overall structure and meets industry flammability standards.

It is yet another feature of the present invention that the flashing is self-regenerating and self-healing.

It will become apparent that these aims and other objects and features are best achieved by a super-hydrophobic flashing for a cavity wall described in detail hereinbelow.

### BRIEF DESCRIPTION OF THE DRAWINGS

In the following drawings, the same parts in the various views are afforded the same reference designators.

FIG. 1 is a perspective view of a water-shedding flashing of this invention and shows a cavity wall with an interior wythe of masonry block and an exterior wythe of brick having a through-walled-mounted flashing membrane installed in the cavity thereof;

FIG. 2 is a perspective view of a water-shedding flashing of this invention and shows a cavity wall with an interior wythe of masonry block and an exterior wythe of brick having a surface-mounted flashing membrane installed in the cavity thereof;

FIG. 3 is a perspective view of the uninstalled water-shedding flashing of this invention with the super-hydrophobic layer broken away and an adhesive layer and release sheet added thereto;

FIG. 4 is a top plan view of a chemical-vapor-deposition surface containing micro/nano surface morphology of the present invention without the super-hydrophobic layer;

FIG. 5 is a perspective view of the water-shedding flashing with water beaded on the modified surface; and

FIG. 6 is a perspective view of a water-shedding flashing of one embodiment of this invention formed with a hydrophobic material therein.

### DESCRIPTION OF THE PREFERRED EMBODIMENTS

In the water-shedding flashings of this invention, flexible membranes are described that undergo a treatment process to obtain a super-hydrophobic surface on the flashings. The super-hydrophobic surface works in cooperation with the channels in the outer wythe to shed water and water vapor expeditiously from the wall cavity out to the exterior of the building. Removal of the water and water vapor is essential to protect the structure from water damage and protect the cavity from mold, mildew or other organic infestations.

It is well understood that the wettability of various materials is dependent on both the physical and chemical heterogeneity of a material. As more fully described in Nun, et al., U.S. Pat. No. 7,211,313, Branson, et al., U.S. Pat. No. 7,485,343 and Boris, et al., U.S. Patent Application Publication No. 2008/0241512, the notion of using the contact angle, Θ, made by a droplet of liquid on a surface of a solid substrate as a quantitative measure of the wetting ability of the particular solid has long been well understood. If a liquid spreads completely across the surface and forms a film, the contact angle Θ is 0 degrees. If there is any degree of beading of the liquid on the surface of the substrate, the surface is considered to be non-wetting. For water, a contact angle of at least 120 degrees, and preferably at least 150 degrees is considered to be super-hydrophobic.

The rolling of liquid droplets and the removal of foreign particles depend on both the hydrophobicity of the surface and on the surface roughness caused by different microstructures. Super-hydrophobic surfaces may be created by processing an existing surface. Typical methods of converting material surfaces to a super-hydrophobic structure include: etching the existing surface to create specific nano-patterns and then coating the surface with a hydrophobic coating; roughening the substrate surface and then coating the surface with a hydrophobic coating; growing a rough film from solutions containing nano-particles or polymers, so as to create a rough and hydrophobic surface on the material; and combining a rough surface with a surface having a low surface energy.

The water-shedding ability of the flashings are based on the mechanisms of adhesion which are generally the result of surface-energy-related parameters relating to interaction of the two surfaces that are in contact. The systems generally attempt to reduce their free surface energy. If the free surface energies between two components are intrinsically very low, it can generally be assumed that there will be weak adhesion between the two components. Where one surface energy is high and one surface energy is low the crucial factor is very often the opportunity for interactive effects. Specific to the present invention, when water is applied to a super-hydrophobic flashing, it is impossible to bring any noticeable reduction in surface energy. The wetting is poor and the water applied forms droplets with a very high contact angle, causing the water to fall from the flashing and be directed out to the exterior surface of the outer wythe.

Super-hydrophobic coatings can be applied using numerous methods which include, but are not limited to, chemical vapor deposition and coating, rolling, dipping, spraying, brushing, and treating with a with a precursor sol comprising a metal alkoxide, an alcohol, a basic catalyst, a fluoroalkyl compound and water. Hydrophobic coatings take varied forms including rough metal oxide films. The metal oxide films can be any number of appropriate compounds containing elements such as titanium, aluminum, zirconium, silicon or similar. A coating of titanium dioxide rutile is preferred given its high refractive indicies and high rate of dispersion.

The water-shedding flashings are formulated to be self-healing and self-regenerative. The self-healing and self-regenerative features are achieved through the use of layers of particles typically from the group consisting of silicates, doped silicates, minerals, metal oxides, silicas, polymers, and silica-coated metal powders. These particles are secured on a carrier consisting of particles and a binder. When the surface particles are ablated, new particles from the carrier are exposed and regenerate the super-hydrophobic surface. To allow self-regeneration, it is necessary for there to be differences in the properties of the material used for the particles and for the binder. When a particle is lost, new particles come to prominence from the binder and replace those lost.

To assist in installing the water-shedding flashing on the exterior surface of the inner wythe, pressure-activated adhesives and release sheets are added to the water-shedding flashings on the installation side of the flashings thereby forming peel-and-stick assemblages, which assemblages enable surface- and through-wall-mounting with a substantial saving of labor. The adhesives employed are state-of-the-art, clear, hot-melt adhesives with formulations that are highly adaptable to the various field uses. Exemplary of the adaptability is that the tackiness of the hot melt adhesive formulation employed is adequate for flashing installation on drywall and on masonry block. Further, when a fibrous material is added to the adhesive to strengthen the overall construct, the tackifier additive is increased to retain the bonding characteristic.

Referring now to FIGS. 1-5, this embodiment of the invention in which a water-shedding flashing assembly or masonry flashing structure referred to generally by the reference designator 10 is shown. In this embodiment, a cavity wall structure 12 is shown having an inner wythe 14 of masonry blocks 16 and an outer wythe 18 of facing brick 20. Although an inner wythe 14 of masonry blocks 16 is shown, the water-shedding flashings of this invention may be applied to alternative materials such as, a drywall inner wythe (not shown). Between the inner wythe 14 and the outer wythe 18, a cavity 22 is formed. Optionally, insulation 44 may be installed. Successive bed joints 24 and 26 are formed between courses of blocks 16 and the joints are substantially planar and horizontally disposed. Also, successive bed joints 28 and 30 are formed between courses of bricks 20 and the joints are substantially planar and horizontally disposed. For the through-wall-mounted flashing installation of this embodiment (FIG. 1), the flashing 42 is shown extending into bed joint 26 of the inner wythe 14 and into bed joint 28 of the outer wythe 18. For the surface-mounted flashing installation, as shown in FIG. 2, the installation includes the use of a termination bar 45.

For purposes of this discussion, the exterior surface 33 of the outer wythe 18 contains a horizontal line or x-axis 34 and an intersecting vertical line or y-axis 36. A horizontal line or z-axis 38 also passes through the coordinate origin formed by the intersecting x- and y-axes. A horizontal line or z-axis 38 also passes through the coordinate origin formed by the intersecting x- and y-axes. In the discussion which follows, it will be seen that the water-shedding flashing 42 of this invention is constructed to work in conjunction with the channels or weep holes 40 and optionally a drip edge 46 in the outer wythe 18 to drain water from the cavity 22. Alternatively, the flashing is channeled or embossed, removing the need for weep holes or exterior wythe channels (not shown). The channels permit air and water to exit the cavity while providing ventilation to the cavity. Removal of water and water vapor is essential to the integrity of the structure and protection against the growth of mold, mildew and other organic infestations.

Referring now to FIG. 3, a perspective view of the water-shedding masonry flashing 10 is shown. An elongated flexible membrane 42 is shown and is constructed from a sheet of laminate material in the 10- to 100-mil range or similar materials. While the membranes hereof are described as consisting of stainless steel, zinc, copper, polyvinyl chloride, ethylene propylene diene monomer, recycled rubber, Elvaloy, low density polyethylene, high density polyethylene, polyethylene teraphalate, polypropylene, styrene isoprene styrene, styrene ethylene butadiene styrene, styrene ethylene propylene, and admixtures thereof other flexible materials, which might fall outside this classification may be used.

As seen in FIGS. 3 through 5, the water-shedding flashing 42 has a modified surface 48 and an unmodified surface 50. The modified surface is conditioned to reduce surface adhesion of water and water vapor and to receive a super-hydrophobic layer 52. The surface is conditioned by etching (not shown), using a chemical-vapor-deposit on the surface, abrading the surface (not shown), or through similar methods to create a textured surface. The chemically-vapor-deposited surface 54 consists of micro/nano particles 56 and is shown in FIGS. 3 and 4. Disposed atop the modified surface 48 is a super-hydrophobic layer 52. The super-hydrophobic layer 52 is preferably a textured titanium dioxide rutile film, although other textured metal oxide films such as titanium oxides, aluminum oxides, zirconium oxides, silicon oxides and similar are effective. Further, other super-hydrophobic precursor sols may be substituted.

As shown in FIG. 5, the modified surface 48 with a super-hydrophobic coating 52 causes water 54 to bead upon contact when in a horizontal form. Upon installation in a vertical manner, the water-shedding flashing 42 prevents the water and water vapor 54 from adhering to the flashing 42 thereby forcing the water to flow down the flashing 42 and be directed to the exterior surface 33 of the outer wythe 18 through the channels 40. Continual flow through the channels 40 prevents blockages in the channels 40. The water-shedding flashing 42 can be optionally made self-regenerative and self-healing (not shown).

Referring again to FIG. 3, the water-shedding masonry flashing 42 is shown as a peel-and-stick product and further includes an adhesive layer 60 which is formulated for pressure activation and compatibility with the flashing membrane or web 42 and the release sheet 62 adhered thereto. The adhesives described herein include, but are not limited to bitumen, clear, and hot melt adhesives. The preferred hot melt adhesives described herein are particularly useful for peel-and-stick applications in building construction industry as such adhesives are readily pressure activated after the release paper is removed. Alternatively, the flashing is produced without the included adhesive layer for installation on-site with separate adhesives or by other methods of installation (not shown).

The adhesive is formulated so that, in case of fire, the coatings thereof will not contribute to smoke or accelerate flame spreading. The adhesive layer 60 optionally includes an inorganic material, namely, an alkali-resistant fiber glass. This additive enhances the overall strength of the flashing system and provides multidirectional reinforcement. Alternative to being doped with the fiber glass additive, the flashing may be strengthened using polymeric fiber fragments. Also, the fiber-doped adhesive layer is formulated to have sufficient tackiness so that a durable bond between the membrane and the rough and porous surface of the masonry block is experienced. The adhesive on the flashing permits butting of the widths of flashing precluding the use of caulks and sealants at the joints. The joints can be further reinforced with sealing tape.

Incorporating by reference the Di Rado et al. patent, U.S. Pat. No. 5,106,447, the hot melt adhesive compositions of hot melt layer 60 may be prepared from 10 to 50 weight percent of a thermoplastic elastomer, namely, thermoplastic polybutene-1/ethylene copolymer containing from about 5.5 to about 10% by weight ethylene (polybutylene); 20 to 50 percent of a tackifier; 15 to 50 percent of an amorphous diluent having a softening point greater than 90 degrees C.; and, 0 to 2 percent of a stabilizer.

The polybutylene copolymers employed herein are copolymers of polybutee-1 and ethylene wherein the ethylene content varies from about 5.5 to about 10% weight of the copolymer. The applicable isotactic polybutylenes are relatively rigid while in their plastic form but flow readily upon being heated. Expressing molecular weight in terms of melt index, the applicable isotactic polybutylenes to be used in the present adhesive should exhibit a melt index in the range of from about 5 to 2000 dg/min and preferably from 400 to 700 dg/min. The latter melt flow values are determined by the method described in ASTM D1238 and are inversely related to molecular weight, i.e., the lower the melt index, the higher the molecular weight. These copolymers are available from Shell Chemical Company under the Duraflex trademark as Duraflex 8310, 8410, 8510, and 8910, with the 8910 having a melt index of about 700, a grade preferred for use herein. Mixtures of these copolymers may also be used.

The tackifying resins which may be used to extend the adhesive properties of the isotactic polybutylene include: (1) hydrogenated wood rosin or rosin ester; (2) polyterpene resins; (3) aliphatic petroleum hydrocarbon resins; and, (4) partially and fully hydrogenated hydrocarbon resins.

The polyterpene resins have a softening point, as determined by an ASTM method E28-58 T, of from about 80 degrees C. To 150 degrees C., the latter polyterpene resins generally resulting from the polymerization of terpene hydrocarbons in the presence of Friedel-Crafts catalysts at moderately low temperatures and including the latter resins which are aromatically modified; examples of commercially available resins of this type being the Nirez resins sold by Reichhold Chemical, the Zonatac resins sold by Arizona, and the Piccolyte S-10, S-25, S-40, S-85, S-100, S-115, S-125 and S-135 resins as sold by Hercules Chemical.

The aliphatic petroleum hydrocarbon resins have a Ball and ring softening point of from about 80 degrees C. To 160 degrees C., resulting from polymerization of monomers consisting primarily of 5 carbon atom olefins and diolefins, and including the latter resins which are aromatically modified, examples of commercially available resins of this type being Wingtack 95 and Wingtack Extra as sold by the Goodyear Tire and Rubber Company and the Escorez 1000 series of resins sold by the Exxon Chemical Corporation.

Examples of the partially and fully hydrogenated hydrocarbon resins are resins such as Resin H-130 from Eastman, Escorez 5000 series from Exxon, and Regalrez from Hercules. The amorphous diluents which are needed and present in the adhesive composition include (atactic) amorphous polypropylene or other similar high softening point (i.e. greater than 90 degrees C.), low crystalline diluent, (e.g. amorphous polyalpha-olefins). These diluents, are used at levels of 20 to 50% by weight, preferable about 20 to 25% by weight.

A suitable release paper is applied thereover. After a prescribed cure period, the release paper 62 is removed and the flashing of this invention is applied to the inner wythe 14. The application to the inner wythe is at room temperature utilizing a hand-operated laminating roller to provide the pressure activation. A spring scale is then attached to the masonry flashing and a 65 lb. force is required to peel the flashing from the block. Repeating the test for SBS-modified, peel-and-stick flashing, a force of 27 lb. (max.) Is required to peel the flashing from the block.

Among the applicable stabilizers or antioxidants utilized herein are included high molecular weight hindered phenols and multifunctional phenols such as sulfur and phosphorous-containing phenols. Representative hindered phenols include: 1,3,5-trimethyl 2,4,6-tris(3,5-di-tert-butyl-4-hydroxy-benzyl)benzene; penta-erythrityl tetrakis-3(3,5-di-tert-butyl-4-hydroxyphenyl) pro-pionate; 4,4′methylenbis(2,6-tert-butyl-phenol); 4,4′-thiobis(6-tert-butyl-o-cresol); 2,6-di-tertbutylphenol; 6-(4-hydroxy-phenoxy)-2,4-bis(n-octyl-thio)-1,3,5-triazine; di-n-octadecyl 3,5-di-tert-butyl-4-hydroxy-benzylphosphonate; 2-(n-octylthio)-ethyl 3,5-di-tert-butyl-4-hydroxybenzoate; and sorbitol hexa[3-(3,5-di-tert-butyl-4-hydroxyphenyl)-propionate].

The performance of these antioxidants may be further enhanced by utilizing, in conjunction therewith known synergists such, for example, as thiodipropionate esters and phosphites. Particularly useful is distearylthiodipropionate. These stabilizers are generally present in amounts of about up to 2 weight percent, preferably 0.25 to 1.0%. Besides the glass fiber reinforcing agent mentioned above, other additives such as flow modifiers, pigments, dyestuffs, etc., which are conventionally added to hot melt adhesives for various end uses may also be incorporated in minor amounts into the formulations of the present invention.

The water-shedding flashing 42 is produced as follows:
(a) providing a membrane 64 having two major surfaces 48, 50, for use in a cavity wall 12;
(b) modifying one of said two major surfaces 48, 50 for the purpose of accepting a super-hydrophobic layer 52 thereon;

The production of the water-shedding flashing 42 further comprises one of the following alternative substeps:
(b)(1) etching said modified surface 48;
(b)(2) providing a chemical-vapor-deposited composition 54 on said modified surface 48;
(b)(3) abrading said modified surface 48; or
(b)(4) growing a rough film from a nano-particle solution on said modified surface 48.
(c) adhering a super-hydrophobic layer 52 on said modified surface 48.

Optionally, the water-shedding flashing 42 further comprises the steps of:
(d) applying an adhesive layer 60 on said unmodified surface 50; and,
(e) disposing a release sheet 62 on said adhesive layer 60, said release sheet 62 being removable prior to mounting said flashing 42 in said cavity 22 of said cavity wall 12.

The water-shedding flashing 42 installation is completed by:
(f) disposing said flashing 42 on the exterior surface 35 of said inner wythe 14 in communication with said channels 40 of said exterior surface 33 of said outer wythe 18.

The water-shedding flashings of this invention enable the erector of a cavity wall to provide a very low moisture cavity wall that reduces material deterioration and removes residual moisture, thereby removing the medium for mold, mildew and other organic infestations. Because of the nature of the prior art flashing materials, water and water vapor removal was limited. This improved novel cavity wall flashing provides a super-hydrophobic surface that facilitates drainage within the wall cavity.

The flashings are designed to communicate with the exterior of the cavity wall and operate as a conduit between the cavity and the channels throughout the exterior surface of the outer wythe to remove water and water vapor from the cavity. The existence of moisture in the cavity hastens the growth of mold, mildew and other unwanted infestations within the cavity and causes the weakening of the physical integrity of the building materials. Improvements in the thermal insulation of cavity wall structures reduces heat exchange between the interior of the building and the exterior surface. Such insulation improvements, while conserving energy and lowering HVAC costs, provides a more friendly atmosphere for mold, mildew and other unwanted microorganism infestation within the cavity. Accordingly, it is essential that water and water vapor be removed from the cavity and directed to outside the exterior of the building.

The present invention focuses on the use of specialized coatings and modified surfaces, which produces a novel super-hydrophobic surface. Such novel flashings provide a water contact angle in the range of at least 120 degrees and preferably over 150 degrees. Such a high water contact angle causes water and water vapor to roll off the flashing and out to the exterior of the outer wythe, thereby solving the prior art issue of residual moisture in the cavity.

As an alternative to adhering a super-hydrophobic layer to the flexible membrane, a membrane 142 can instead be formed from a compound containing hydrophobic and/or super-hydrophobic materials (see FIG. 6). The flashing 142 can be extruded from a master batch containing both resin pellets and compounds with hydrophobic properties, such as metal oxides including titanium dioxide rutile, titanium oxides, aluminum oxides, zirconium oxides, silicon oxides, or similar. Any suitable chemical compound that creates a hydrophobic or super-hydrophobic surface or alters the property of a substance to which it has been added to promote the shedding of water and prevent water molecules from attaching to a surface can be used within the scope of the present invention. The resin matrix can be any material described above as suitable for forming the flashing 42, such as polyvinyl chloride, ethylene propylene diene monomer, recycled rubber, Elvaloy, low density polyethylene, high density polyethylene, polyethylene teraphalate, polypropylene, styrene isoprene styrene, styrene ethylene butadiene styrene, styrene ethylene propylene, and admixtures thereof, or any other suitable flexible materials. The hydrophobic compounds and the resin pellets can be added to the extruder by a volumetric, gravimetric multi-component feeder, as is known in the art. In one embodiment, the master batch used to form the water shedding flashings 142 is approximately 50% to 90% resin and approximately 10% to 50% hydrophobic additive. The master batch containing the resin and the hydrophobic additive is thoroughly mixed during the extrusion process, resulting in a substantially uniform composite forming the flashing 142 with hydrophobic qualities.

Alternatively, the hydrophobic compound can be introduced in a liquid state further along the extruder barrel by a melt pump injector. In this process, the hydrophobic additive is mixed in with the resin later in the extrusion process. There must be sufficient mixing downstream of the injection port so that the hydrophobic additive is fully mixed into the resin, resulting in a substantially uniform composite forming the flashing with hydrophobic qualities.

As described above with reference to the previous embodiments, the water-shedding masonry flashing 142 can be a peel-and-stick product and further includes an adhesive layer 160 which is formulated for pressure activation and compatibility with the flashing membrane or web 142 and the release sheet 162 adhered thereto. The adhesive layer can be the same as described above, and as such will not be described again.

The water shedding flashing 142 formed from resin with a hydrophobic additive, whether the additive is mixed with the resin at the beginning of the extrusion process or later in the extrusion process, exhibits the same hydrophobic qualities as the water shedding flashing 42 having a super-hydrophobic layer adhered to a surface of the flashing. Because the hydrophobic and super-hydrophobic materials are added into the resin used to form the flashing 142 and do not simply coat a single surface of the flashing, the flashing may offer better hydrophobic qualities. Every surface 152 of the flashing 142 can have hydrophobic or super-hydrophobic qualities. As described above with reference to flashing 42, the flashing 142 causes water to bead upon contact and prevents the water and water vapor from adhering to the flashing. The water is thereby forced to flow down the flashing 142 and be directed to the exterior surface of the outer wythe through the channels or weep holes.

In the above embodiments, the best modes of practicing this invention have been described. While the examples are specific as to the water-shedding flashings employed, variations can be made without departing from the spirit of the invention.

What is claimed is:

1. A water-shedding flashing sized and shaped to drain water away from a building, the flashing comprising an elongate flexible membrane including a matrix and hydrophobic material within the matrix, the hydrophobic material within the matrix being present at surfaces of the membrane in quantities to reduce surface adhesion of water on the elongate flexible membrane.

2. A water-shedding flashing as recited in claim 1, wherein the hydrophobic material is dispersed throughout the matrix.

3. A water-shedding flashing as recited in claim 2, wherein the hydrophobic material is uniformly dispersed throughout the matrix.

4. A water-shedding flashing as recited in claim 1, wherein the hydrophobic material is intermixed with the matrix.

5. A water-shedding flashing as recited in claim 1, wherein the matrix comprises a resin.

6. A water-shedding flashing as recited in claim 5, wherein the resin comprises approximately 50%-90% of the matrix.

7. A water-shedding flashing as recited in claim 6, wherein the hydrophobic material comprises approximately 10%-50% of the matrix.

8. A water-shedding flashing as recited in claim 5, wherein the resin is selected from a group consisting of polyvinyl chloride, ethylene propylene diene monomer, recycled rubber, Elvaloy, low density polyethylene, high density polyethylene, polyethylene teraphalate, polypropylene, styrene isoprene styrene, styrene ethylene butadiene styrene, and styrene ethylene propylene.

9. A water-shedding flashing as recited in claim 1, wherein the hydrophobic material is selected from a group consisting of titanium dioxide rutile, titanium oxide, aluminum oxide, zirconium oxide, and silicon oxide.

10. A water-shedding flashing as recited in claim 1, wherein the reduction of the surface adhesion of water on the elongate flexible membrane is characterized by a water contact angle of at least 120 degrees.

11. A water-shedding flashing as recited in claim 1, wherein the reduction of the surface adhesion of water on the elongate flexible membrane is characterized by a water contact angle of at least 150 degrees.

12. A water-shedding flashing as recited in claim 1, further comprising an adhesive layer disposed on the elongate flexible membrane for use in mounting the elongate flexible membrane on a cavity wall such that the water shedding flashing facilitates the removal of water and water vapor from the cavity wall.

13. A water-shedding flashing as recited in claim 12, further comprising a release sheet disposed on the adhesive layer.

14. A method of making a water-shedding flashing comprising:
providing a matrix material;
introducing a hydrophobic material to the matrix material;
mixing the matrix material and the hydrophobic material to form a matrix;
extruding an elongate flexible membrane sized and shaped to drain water away from a building from the matrix to form a water-shedding flashing having the hydrophobic material present at the surfaces of the elongate flexible membrane.

15. A method as recited in claim 14, wherein providing a matrix material comprises providing resin pellets and introducing a hydrophobic material comprises introducing hydrophobic material pellets for mixing with the resin pellets.

16. A method as recited in claim 14, wherein introducing a hydrophobic material comprises introducing the hydrophobic material in liquid form for mixing with the matrix material.

17. A method as recited in claim 14, wherein mixing the matrix material and the hydrophobic material comprises forming a substantially uniform composite matrix.
